(19) United States
(12) Patent Application Publication
(10) Pub. No.: US 2007/0239844 A1
(43) Pub. Date: Oct. 11, 2007

(54) IMAGE PROCESSING APPARATUS AND METHOD FOR TRANSMITTING DISPLAY SCREEN

(75) Inventors: Tetsuya Yokoyama, Kawasaki-shi (JP); Hiroshi Uchikawa, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/688,335

(22) Filed: Mar. 20, 2007

(30) Foreign Application Priority Data
Mar. 23, 2006 (JP) 2006-080486
Mar. 9, 2007 (JP) 2007-060100

(51) Int. Cl. G06F 15/16; G06F 15/173; G06F 3/00

(52) U.S. Cl. 709/217; 715/748; 709/225

(57) ABSTRACT

A method and an image processing apparatus capable of communicating with a client apparatus including storing an electronic document whose access right is controlled, displaying an electronic document stored in the storing unit, receiving a transfer request from the client apparatus to transfer contents of a display screen to be displayed on a displaying unit of the image processing apparatus, transmitting to the client apparatus, in response to the transfer request, screen data corresponding to the screen to be displayed by the displaying unit, and controlling, when the transfer request is received while the electronic document whose access right is controlled is to be displayed, not to transmit at least a portion of the screen data.

### BACKGROUND OF THE INVENTION

1. Field of the Invention

The present invention relates to processing of a remote request in an image processing apparatus that processes a request received from a client apparatus for an electronic document whose access right is controlled stored in the image processing apparatus.

2. Description of the Related Art

To prevent information leakage, a document management system that permits only an authorized user to view, edit, and print an electronic document is being developed and becoming commercially available.

A document management system for controlling an access right by, for example, disabling viewing of an electronic document after its expiration date is also being developed and becoming commercially available.

A dedicated application for displaying such an electronic document whose access right is controlled has a function of prohibiting capturing of a display screen in a running information processing apparatus, thus preventing a captured image from being illegally used.

An image processing apparatus has a storage function called a box, which can store many electronic documents, enable input and output of the electronic documents in various ways, and display and edit them.

Operations performed on these electronic documents can be displayed on not only an operation unit incorporated in the apparatus but also a display device at a remote client by transferring a display screen using, for example, a remote framebuffer (RFB) protocol used in virtual network computing (VNC) (see, for example, Japanese Patent Laid-Open No. 2005-65053). The RFB protocol is a protocol for transferring to an external terminal a bitmap image stored in a frame buffer (or video RAM) for displaying an image on a display device.

Even for an electronic document whose access right is controlled, bitmap data for displaying the electronic document on a screen is no longer controlled under the access right. Unfortunately, therefore, an electronic document whose access right was originally controlled can be transferred to the outside as image data whose access is not restricted by transferring a display screen to the outside by use of the VNC using the RFB protocol.

The related technique described above has difficulty dealing with a situation in which other users can secretly view the screen by operating the RFB protocol while a display device in an operation unit in an image processing apparatus is displaying an electronic document whose access right is controlled.

### SUMMARY OF THE INVENTION

The present invention provides a mechanism that can prevent an electronic document whose access right is controlled from being viewed or acquired by a remote user.

According to a first aspect of the present invention, an image processing apparatus capable of communicating with a client apparatus includes a storing unit configured to store an electronic document whose access right is controlled, a displaying unit configured to display an electronic document stored in the storing unit, a receiving unit configured to receive a transfer request from the client apparatus to transfer contents of a display screen to be displayed on the displaying unit, a screen transmitting unit configured to transmit to the client apparatus, in response to the transfer request, screen data corresponding to the screen to be displayed by the displaying unit, and a controlling unit configured to control the screen transmitting unit not to transmit at least a portion of the screen data when the receiving unit receives the transfer request while the displaying unit is displaying the electronic document whose access right is controlled.

According to a second aspect of the present invention, an image processing apparatus capable of communicating with a client apparatus includes a storing unit configured to store an electronic document whose access right is controlled, a displaying unit configured to display an electronic document stored in the storing unit, a receiving unit configured to receive a transfer request from the client apparatus to transfer contents of a display screen to be displayed on the displaying unit, a screen transmitting unit configured to transmit to the client apparatus, in response to the transfer request, screen data corresponding to the screen to be displayed by the displaying unit in response to the transfer request received by the receiving unit, and a controlling unit configured to control a transmission of the screen data to the client apparatus by the screen transmitting unit based on whether a user of the client apparatus has an access right for the electronic document.

Further features of the present invention will become apparent from the following description of exemplary embodiments with reference to the attached drawings.

### BRIEF DESCRIPTION OF THE DRAWINGS

FIG. 1 illustrates a document processing system that applies an image processing apparatus according to a first exemplary embodiment of the present invention.

FIG. 2 is a block diagram of a hardware configuration in the image processing apparatus according to the first exemplary embodiment.

FIG. 3 is a flowchart illustrating a first data processing procedure performed by the image processing apparatus according to the first exemplary embodiment.

FIG. 4 illustrates a login dialog box displayed on a display device illustrated in FIG. 2.

FIG. 5 is a flowchart illustrating a second data processing procedure performed by the image processing apparatus according to the first exemplary embodiment.

FIG. 6 is a flowchart illustrating a third data processing procedure performed by the image processing apparatus according to a third exemplary embodiment of the present invention.

FIG. 7 is an illustration for describing a memory map of a storage medium that stores various data processing programs readable by the image processing apparatus according to at least one of the exemplary embodiments of the present invention.

### DESCRIPTION OF THE EMBODIMENTS

Exemplary embodiments are described below with reference to the drawings.

System Configuration

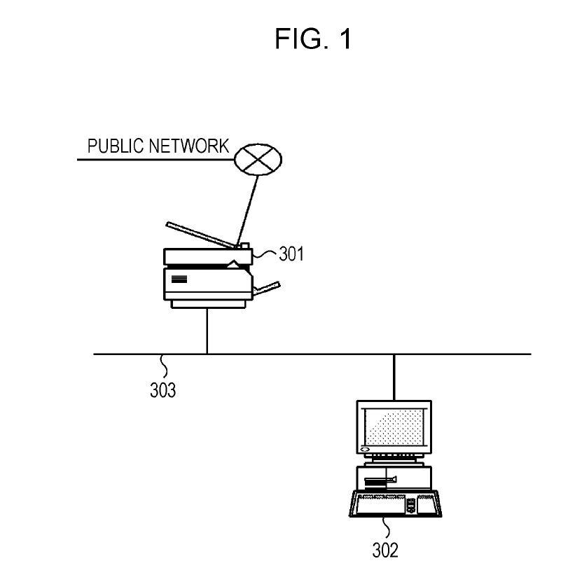

FIG. 1 illustrates a document processing system that applies an image processing apparatus according to a first exemplary embodiment of the present invention.

In FIG. 1, an electronic document stored in an external storage unit in an image processing apparatus 301 is transmitted to a remote client apparatus 302, and the electronic document is displayed on a display unit in the remote client apparatus 302. The image processing apparatus 301 is connected to the remote client apparatus 302 over a computer network 303 (e.g., local area network (LAN)).

The remote client apparatus 302 includes hardware resources (e.g., a central processing unit (CPU), a read-only memory (ROM), and a random-access memory (RAM)), which will be described below, and a software resource for performing a control procedure, which will be described below. In the present embodiment, the remote client apparatus 302 is a personal computer (PC), but is not limited to a PC, and any apparatus that would enable practice of the present invention is applicable. The image processing apparatus 301 is also connected to a public network. The remote client apparatus 302 has a VNC client software installed therein.

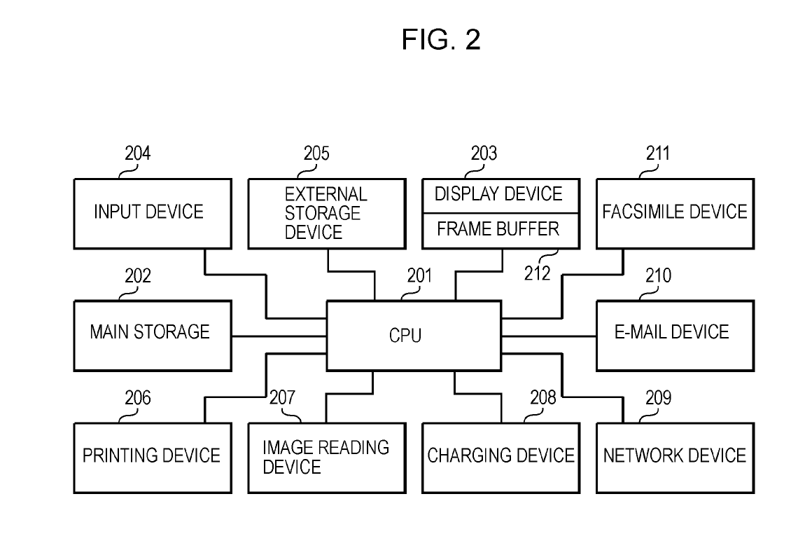

FIG. 2 is a block diagram illustrating a hardware configuration of the image processing apparatus 301 according to the present embodiment.

In FIG. 2, CPU 201 controls a main storage 202, a display device 203, an input device 204, an external storage device 205, a printing device 206, an image reading device 207, and a charging device via an internal bus (not shown). The CPU 201 also has a function of performing the normal four basic operations of arithmetic and logical operation. Additionally, the CPU 201 performs data communication with an external apparatus via a network device 209 using a predetermined protocol. The CPU 201 performs e-mail data communications with an external apparatus via an e-mail device 210 using a predetermined protocol. The CPU 201 performs facsimile data communication with an external facsimile device via a facsimile device 211.

The main storage 202 can be constructed of a DRAM, for example, and can expand its capacity. The CPU 201 can store necessary information in the main storage 202 and can extract it on an as needed basis.

The display device 203 displays a screen for operation of the image processing apparatus 301 and an electronic document stored in the external storage device 205. Examples of the display device 203 include, but are not limited to, a CRT, a LCD, or a touch panel. The input device 204 performs various kinds of input to the CPU 201. A frame buffer (VRAM) 212 stores bitmap data of a screen displayed on the display device 203. In the case in which document information is displayed on the display device 203, bitmap data generated from the document information is stored in the frame buffer 212.

The external storage device 205 stores various kinds of information, such as document information or a program. Examples of the external storage device 205 include, but are not limited to, a magnetic storage and a magneto-optical storage.

In the present embodiment, document information in, for example, portable document format (PDF) received from the e-mail device 210 or the network device 209 by the CPU 201 is stored in the external storage device 205. At least one of document information items stored in the external storage device 205 is an information item whose operable rights are defined for each user. Such a document is referred to as document information with controlled access rights. The external storage device 205 can store a document without controlled access rights.

The printing device 206 prints results of image processing performed by the image reading device 207 or the CPU 201 (e.g., figures and characters). The image reading device 207 converts an image of a paper document read by a CCD image sensor (not shown) into electronic information. The image data of a document read by the image reading device 207 can be converted into the above-described PDF format and stored as document information in the external storage device 205. In this case, if needed, the document information can be set as document information whose access right is controlled by defining access rights for each user to the document information. The access right for each user to document information is defined by an instruction from a user through the input device 204 or other devices.

A charging device 208 performs management for charging for copy processing, printing processing, scan processing, and other processing. The network device 209 enables communications via the computer network 303 using a predetermined protocol. The e-mail device 210 manages e-mail transmission/reception to the outside over the computer network 303. The facsimile device 211 manages facsimile transmission/reception to an external facsimile device.

The external storage device 205 stores VNC server software. The VNC server software stored in the external storage device 205 is loaded into the main storage 202 and executed by the CPU 201, thereby causing the image processing apparatus 301 to function as a VNC server. This enables an image of a screen being displayed on the display device 203, i.e., bitmap data stored in the frame buffer 212, to be transferred on the basis of a request from the remote client apparatus 302 activating VNC client software on the computer network 303.

The image processing apparatus 301 according to the present embodiment communicates with the remote client apparatus 302 using the RFB protocol and performs processing for an electronic document, whose viewing right is controlled, stored in the external storage device 205.

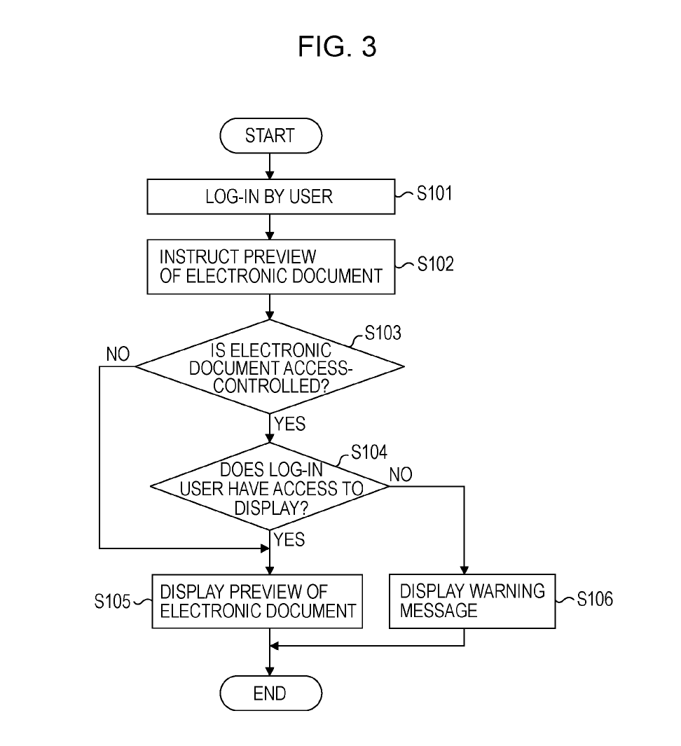

An updatable management table that stores information about users of the remote client apparatus 302 and rights of the users is stored in the external storage device 205. The registered information can be deleted by an administrator. The CPU 201 has a function of receiving a screen-transfer request to transfer the display content from the remote client apparatus 302 via the network device 209 while an electronic document is being displayed on the display device 203. The screen-transfer request is issued from the remote client apparatus 302 using the above-described RFB protocol. When receiving the screen-transfer request for the display content in the receiving function, the CPU 201 determines acceptance or rejection of the screen-transfer request based on the attributes of an electronic document being displayed on the display device 203 and information about the user rights stored in the management table in accordance with a procedure illustrated in FIG. 3, which will be described below.

The CPU 201 has a function of, in the case where the request from the remote client apparatus 302 is rejected, informing the requesting remote client apparatus 302 of descriptions of the rejection via the network device 209.

FIG. 3 is a flowchart illustrating a first data processing procedure in the image processing apparatus according to the present embodiment. This processing illustrates an example of control of a preview image display by the image processing apparatus 301. Steps S101 to S106 are implemented by loading of a control program stored in the external storage device 205, a ROM, or other media into the main storage 202 and execution of the program by the CPU 201.

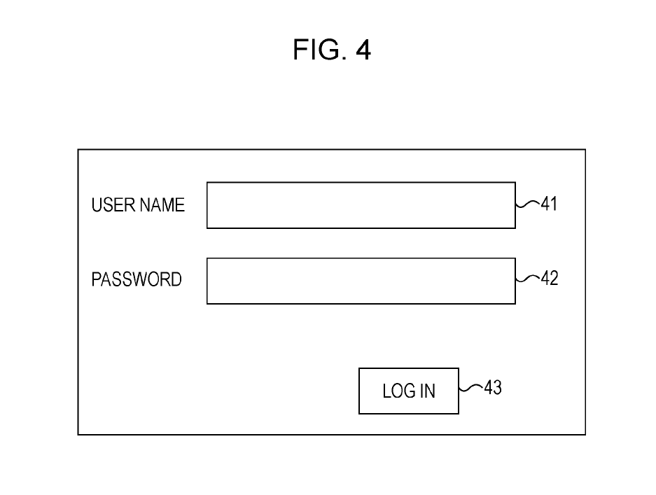

First, in step S101, a user logs into the image processing apparatus 301. FIG. 4 illustrates an example of a login dialog box displayed on the display device 203 illustrated in FIG. 2. More specifically, FIG. 4 illustrates a login dialog box displayed by the image processing apparatus according to the present embodiment. A user enters a user name in the user name entry field 41 and a password associated with the user name into the password entry field 42. A login button 43 is used to confirm the entry in the user name entry field 41 and the password entry field 42. A card medium, such as an IC card, can be used to log in.

In step S102, a user that successfully logs onto the image processing apparatus 301 selects a desired electronic document stored in the image processing apparatus 301 and instructs the display device 203 to display a preview image of the electronic document.

Next, in step S103, the CPU 201 determines whether the electronic document selected by the user in step S102 is an electronic document whose access right is controlled. If, in step S103, the CPU 201 determines that the electronic document selected by the user is an electronic document whose access right is controlled, then flow proceeds to step S104, where the CPU 201 determines whether the logged in user has a right to display the electronic document. The CPU 201 controls a table for determining whether a logged in user has a right to display an electronic document. The table is stored in the external storage device 205 and loaded into the main storage 202 during system startup.

Similarly, the CPU 201 controls a table for determining whether an electronic document stored in the external storage device 205 is access controlled. This table is also stored in the external storage device 205 and loaded into the main storage 202 during system startup. If, in step S104, the user is determined to have a right to display the electronic document, then in step S105, the display device 203 displays a preview of the electronic document.

If, in step S104, it is determined that the user does not have a right to display the electronic document, then flow proceeds to step S106, where the user is notified as such, for example, by a warning message displayed on the display device 203, and the processing is completed.

If, in step S103, it is determined that the electronic document selected by the user is not an electronic document whose access right is controlled, then flow proceeds to step S105, where the display device 203 displays the preview of the selected electronic document, and the processing is completed.

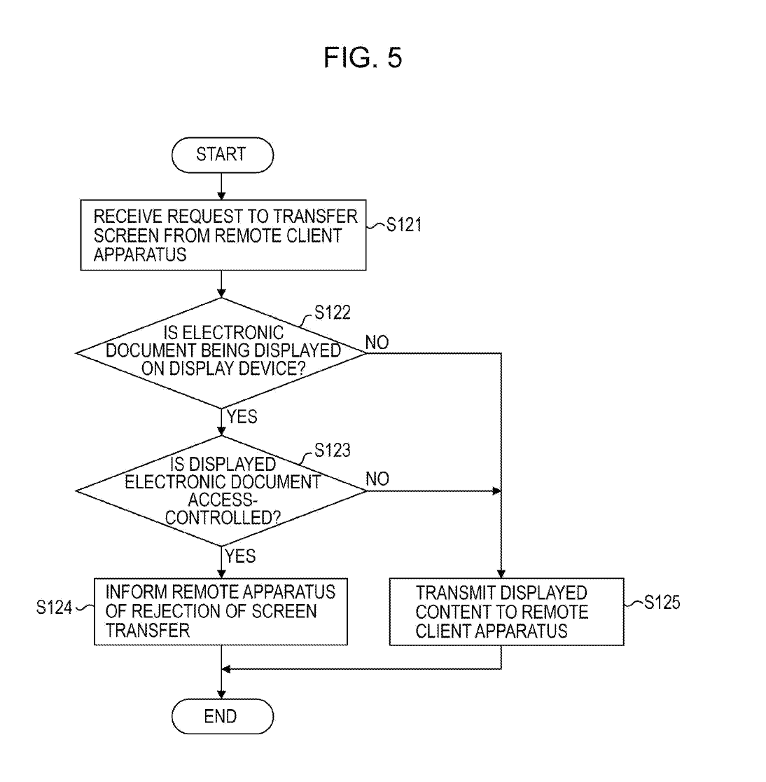

FIG. 5 is a flowchart illustrating a second data processing procedure in the image processing apparatus according to the present embodiment. This processing illustrates an example of processing occurring when a screen-transfer request to transfer a screen is transmitted from the remote client apparatus 302 to the image processing apparatus 301. Steps S121 to S125 are implemented by loading of a control program stored in the external storage device 205, a ROM, or other media into the main storage 202 and execution of the program by the CPU 201.

First, in step S121, a screen-transfer request using the RFB protocol is received from the remote client apparatus 302 that has installed VNC client software. Then, in step S122, the CPU 201 determines whether the content being displayed on the display device 203 contains a preview image of an electronic document. If bit map data to display a preview of an electronic document are stored by VRAM 212, CPU 201 determines that it is in condition to display an electronic document.

If, in step S122, the CPU 201 determines that the content being displayed on the display device 203 contains the preview image of the electronic document, then in step S123, the CPU 201 determines whether the electronic document is an electronic document whose access right is controlled. The CPU 201 makes this determination by referring to the table stored and managed in the external storage device 205.

If, in step S123, the CPU 201 determines that the electronic document is an electronic document whose access right is controlled, then in step S124, the CPU 201 notifies the remote client apparatus 302 that the screen-transfer request from the remote client apparatus 302 has been rejected, and the processing is completed.

If, in step S122, the CPU 201 determines that the content being displayed on the display device 203 does not contain a preview image of the electronic document, flow proceeds to step S125, where the CPU 201 transmits to the remote client apparatus 302 the display content being displayed on the display device 203, i.e., bitmap data stored in the frame buffer 212, and then the processing is completed. For transmission of bitmap data stored in the frame buffer 212 to the remote client apparatus 302, the bitmap data may be transferred after being compressed. If the content being displayed on the display device 203 does not contain a preview image of the electronic document, image data that has a low risk of information leakage, such as an operation screen of the image processing apparatus, is transmitted to the remote client apparatus 302.

If, in step S123, the CPU 201 determines that the electronic document being displayed on the display device 203 is not access controlled, flow proceeds to step S125, where the CPU 201 transmits to the remote client apparatus 302 the display content being displayed on the display device 203, and the processing is completed. Therefore, if the electronic document being displayed on the image processing apparatus 301 is access controlled, a request from the remote client apparatus 302 for acquiring display data thereof can be rejected.

In other words, displaying of a display image of an electronic document whose access right is controlled on a display device in the remote client apparatus 302 by transfer of a display screen can be prevented. Therefore, the risk of information leakage caused by secret viewing of an electronic document whose access right is controlled by another user can be avoided.

In the first exemplary embodiment, in step S124, access from the remote client apparatus 302 is rejected. In a second exemplary embodiment, the CPU 201 has an image processing function of, in the case where the CPU 201 determines to reject a screen-transfer request, performing a masking processing. The masking process, which conceals a display content, is performed on screen data corresponding to a specified region within a display content being displayed on the display device 203, where the specified region is not allowed to be displayed. In addition, the CPU 201 has a function of transferring screen data subjected to the mask processing to the requesting remote client apparatus 302 using a specific protocol.

In the second exemplary embodiment, before the display content being displayed on the display device 203 is transmitted to the remote client apparatus 302, a display region, corresponding to a preview image of an electronic document whose access right is controlled, being displayed on the display device 203 is masked. The CPU 201 transmits the masked display content to the remote client apparatus 302. More specifically, of bitmap data in the frame buffer 212, a region that displays an electronic document whose access right is controlled is replaced with specific image data (e.g., solid black image data).

Therefore, screen data can be transmitted to the remote client apparatus 302 such that the content of an electronic document whose access right is controlled cannot be recognized. Hence, the content of an electronic document whose access right is controlled can be prevented from being leaked.

The image processing apparatus 301 according to a third exemplary embodiment communicates with the remote client apparatus 302 using the RFB protocol. The image processing apparatus 301 performs processing on an electronic document, whose viewing is controlled, stored in the external storage device 205.

An updatable management table that stores information about users of the remote client apparatus 302 and rights of the users is stored in the external storage device 205. The registered information can be deleted by an administrator.

The CPU 201 has a function of receiving an acquisition request for acquiring any electronic document stored in the external storage device 205 from the remote client apparatus 302 via the network device 209. The CPU 201 also has a function of, in the case where the CPU 201 receives an acquisition request for acquiring an electronic document, determining acceptance or rejection of the acquisition request for the electronic document whose acquisition is being requested based on the attributes of the electronic document whose acquisition is being requested and access rights stored in the management table.

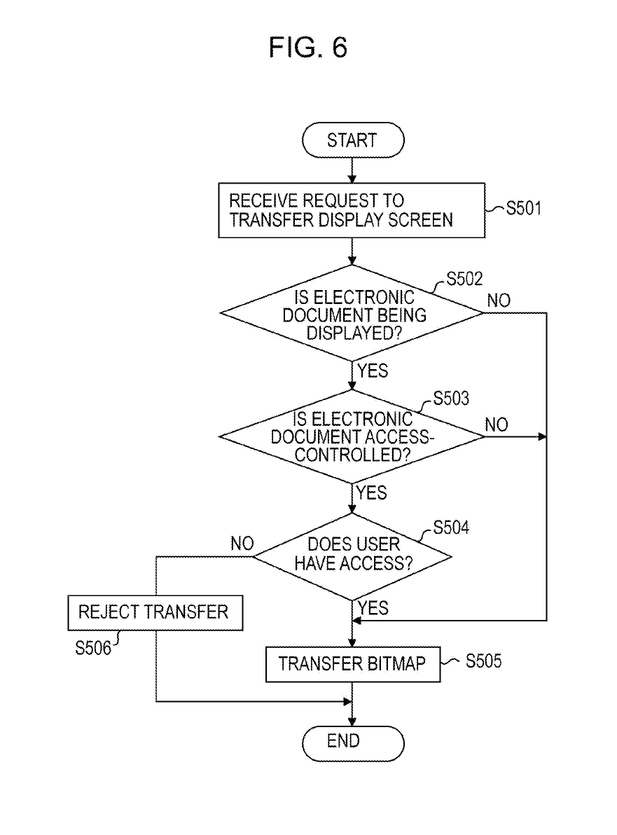

FIG. 6 is a flowchart illustrating a third data processing procedure performed in the image processing apparatus according to the third exemplary embodiment. This processing illustrates another example of processing occurring when a transmission request to transmit a display screen is sent from the remote client apparatus 302 to the image processing apparatus 301. Steps S501 to S506 are implemented by loading of a control program stored in the external storage device 205, a ROM, or other media into the main storage 202 and execution of the program by the CPU 201.

First, in step S501, the CPU 201 receives a transfer request to transfer a display screen using the RFB protocol from the remote client apparatus 302 via the network device 209. Next, in step S502, the CPU 201 determines whether the content being displayed on the display device 203 contains a preview image of an electronic document. If content being displayed contains a preview image, the processing proceeds to step S503. If the content being displayed contains a preview image, the processing proceeds to step S505.

In step S503, the CPU 201 determines whether the electronic document being displayed on the display device 203 is an electronic document whose access right is controlled by referring to the table. If, in step S503, the CPU 201 determines that the electronic document whose access right is controlled is being displayed, the processing proceeds to step S504. If, in step S503, the CPU 201 determines that the electronic document whose access right is controlled is not being displayed, the processing proceeds to step S505. In step S504, the CPU 201 determines whether a user who is making the transfer request (i.e., a user who operates the remote client apparatus 302) holds a right to print the electronic document being displayed on the display device 203 by referring to the table.

If, in step S504, the CPU 201 determines that the user operating the remote client apparatus 302 holds a right to print the electronic document being displayed on the display device 203, the processing proceeds to step S505. In step S505, bitmap data in the frame buffer 212 is transmitted to the remote client apparatus 302.

If, in step S504, the CPU 201 determines that the user operating the remote client apparatus 302 does not hold a right to print the electronic document being displayed on the display device 203, the processing proceeds to step S506. In step S506, a notification that the transfer request from the remote client apparatus 302 has been rejected is transmitted to the requesting remote client apparatus 302, and the processing is completed. In the present embodiment, in step S504, the determination is based on a right to print. However, the determination may be based on other rights, for example, a right to edit an electronic document.

Therefore, in the case where an acquisition request for acquiring an electronic document stored in the image processing apparatus 301 is received from the remote client apparatus 302, if the electronic document whose acquisition has been requested is access controlled, the acquisition request can be requested. According to the present embodiment, an electronic document, whose access right is controlled, being displayed on the operation unit in the image processing apparatus can be prevented from being secretly viewed by another user.

In addition, a screen that is displaying a document that is allowed to be displayed but not allowed to be printed can be prevented from being captured on a PC, and thus the image can be prevented from being printed. Therefore, the security of access to an electronic document whose access right is controlled is improved.

Similarly, even when a document is displayed by a general-purpose application using the HTTP protocol, such as a browser, a capture of a display screen on the remote client can be prevented. Therefore, information leakage can be prohibited, and an advantage of improving the security is obtained.

In the above-described exemplary embodiments, the image processing apparatus has a function of storing and managing an electronic document whose access right is controlled in the external storage device 205, the so-called box function. However, the image processing apparatus is applicable to a case in which an electronic document stored in another remote apparatus outside the image processing apparatus 301 on a network is displayed on the display device 203 in the image processing apparatus 301.

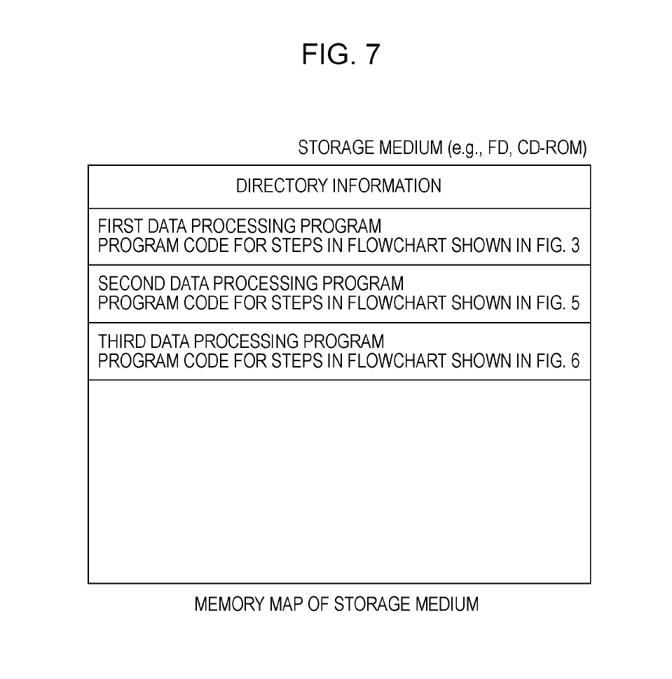

FIG. 7 is an illustration for describing a memory map of a storage medium that stores various data processing programs readable by the image processing apparatus according to at least one of the above described exemplary embodiments.

Although not illustrated in FIG. 7, information for managing programs stored in the storage medium (e.g., version information and information about a creator) may also be stored, and information dependent on an operating system at a side that reads a program (e.g., an icon that identifies a program) may be stored.

Data associated with the various programs is also managed by the directory. A program for installing the various programs into a computer and a program for decompressing a compressed install program may also be stored.

The functions described with reference to FIGS. 3, 5, and 6 may be executed by a host computer using a program installed from the outside. In this case, information items including a program may be supplied to an output device from a storage medium, such as a CD-ROM, a flash memory, or a floppy disk, or from an external storage medium over a network.

As described above, the present invention can also be achieved by supplying a storage medium that stores program code of software that performs the functions according to the foregoing exemplary embodiments to a system or an apparatus and by causing a computer (or CPU or MPU) of the system or the apparatus to read and execute the program code stored in the storage medium.

In this case, the program code itself read out of the storage medium realizes the novel functions of the above-described embodiments. Therefore, the storage medium storing the program code can also realize the present invention.

The program may have any form, such as object code, a program executed by an interpreter, and script data supplied to an operating system, as long as it has functions of the program.

Examples of a storage medium for supplying the program code include, but are not limited thereto, a floppy disk, a hard disk, an optical disk, a magneto-optical disk (MO), a compact disk read-only memory (CD-ROM), a CD recordable (CD-R), a CD-Rewritable (CD-RW), magnetic tape, a nonvolatile memory card, a ROM, and a digital versatile disk (DVD).

Another method for supplying a program is to connect a website over the Internet using a browser in a client computer and download a computer program itself according to the exemplary embodiments or a compressed file including an automatic install function from the website to a storage medium (e.g., a hard disk). Alternatively, the program may be supplied by downloading from different websites of a plurality of files into which program code for the exemplary embodiments of the present invention divided. In other words, a world wide web (WWW) server or a file transfer protocol (FTP) server for allowing a program file that causes a computer to perform the functional processing according to the exemplary embodiments of the present invention to be downloaded by a plurality of users is included in the scope of the following claims.

Encrypting program according to the exemplary embodiments of the present invention, storing the encrypted program in storage media, such as CD-ROMs, and distributing them to users is applicable. In this case, a user who satisfies a predetermined condition is allowed to download information regarding a decryption key from a website over the Internet and to execute the encrypted program using the information regarding the key, thereby enabling the user to install the program in a computer.

The functions of the exemplary embodiments described above can be realized not only by execution of program code read by a computer but also by performance of actual processing in part or in entirety by an operating system (OS) running on a computer in accordance with instructions of the program code.

The functions of the exemplary embodiments described above can be realized by writing of the program code read out of the storage medium into a memory of a function expansion board of a computer or a memory of a function expansion unit connected to a computer. In this case, after the program code is written, a CPU in the function expansion board or in the function expansion unit executes some of or all of the functions in the above-described exemplary embodiments under the control of the program code.

As described above, according to the exemplary embodiments, even when a request to perform document processing whose right is set using a specific protocol is received from a user who does not have a right at a remote client, a risk of allowing the remote user to view or acquire a confidential electronic document can be prevented by determination of acceptance or rejection of the request.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-080486 filed Mar. 23, 2006 and No. 2007-060100 filed Mar. 9, 2007, which are hereby incorporated by reference herein in their entirety.

What is claimed is:

1. An image processing apparatus capable of communicating with a client apparatus, the image processing apparatus comprising:
a storing unit configured to store an electronic document whose access right is controlled;
a displaying unit configured to display an electronic document stored in the storing unit;
a receiving unit configured to receive a transfer request from the client apparatus to transfer contents of a display screen to be displayed on the displaying unit;
a screen transmitting unit configured to transmit to the client apparatus, in response to the transfer request, screen data corresponding to the display screen to be displayed by the displaying unit; and
a controlling unit configured to control the screen transmitting unit not to transmit at least a portion of the screen data when the receiving unit receives the transfer request while the displaying unit is displaying the electronic document whose access right is controlled.

2. The image processing apparatus according to claim 1, further comprising:
a screen-data storing unit configured to store screen data displayed on the displaying unit,
wherein the screen transmitting unit is configured to transmit to the client apparatus the screen data stored in the screen-data storing unit.

3. The image processing apparatus according to claim 1, wherein, the controlling unit is configured to, when the receiving unit receives the transfer request to transfer the contents of the display screen while the displaying unit is not displaying the electronic document whose access right is controlled, control the screen transmitting unit to transmit the screen data to the client apparatus.

4. The image processing apparatus according to claim 1, wherein, when the receiving unit receives the transfer request to transfer the contents of the display screen while the displaying unit is displaying the electronic document whose access right is controlled, the controlling unit is configured to control the screen transmitting unit to transmit screen data in which a screen display region corresponding to the electronic document whose access right is controlled is concealed in the display screen to be displayed by the display unit.

5. The image processing apparatus according to claim 1, wherein, when the receiving unit receives the transfer request to transfer the contents of the display screen while the displaying unit is displaying the electronic document whose access right is controlled, the controlling unit is configured to control the screen transmitting unit to transmit screen data corresponding to a region other than a screen display region corresponding to the electronic document whose access right is controlled in the display screen to be displayed by the display unit.

6. The image processing apparatus according to claim 1, wherein, when the receiving unit receives the transfer request to transfer the contents of the display screen while the displaying unit is displaying the electronic document whose access right is controlled, the controlling unit is configured to transmit to the client apparatus a message that the transfer request has been rejected.

7. An image processing apparatus capable of communicating with a client apparatus, the image processing apparatus comprising:
a storing unit configured to store an electronic document whose access right is controlled;
a displaying unit configured to display an electronic document stored in the storing unit;
a receiving unit configured to receive a transfer request from the client apparatus to transfer contents of a display screen to be displayed on the displaying unit;
a screen transmitting unit configured to transmit to the client apparatus, in response to the transfer request, screen data corresponding to the screen to be displayed by the displaying unit; and
a controlling unit configured to control a transmission of the screen data to the client apparatus by the screen transmitting unit based on whether a user of the client apparatus has an access right for the electronic document.

8. A method for transmitting the contents of a display screen for use in an image processing apparatus capable of communicating with a client apparatus, the image processing apparatus including a storing unit configured to store an electronic document whose access right is controlled and a displaying unit configured to display an electronic document stored in the storing unit, the method comprising:
displaying a display screen on the display unit;
receiving a transfer request from the client apparatus to transfer contents of the display screen to be displayed on the displaying unit;
transmitting to, in response to the transfer request, the client apparatus screen data corresponding to the screen to be displayed by the displaying unit; and
controlling, when the transfer request is received while the electronic document whose access right is controlled is to be displayed on the display unit, not to transmit at least a portion of the screen data.

9. A computer-readable storage medium storing computer-executable process steps, the computer-executable process steps causing a computer to execute the method of claim 8.

10. A method for transmitting the contents of a display screen for use in an image processing apparatus capable of communicating with a client apparatus, the image processing apparatus including a storing unit configured to store an electronic document whose access right is controlled and a displaying unit configured to display an electronic document stored in the storing unit, the method comprising:
displaying a display screen on the display unit;
receiving a transfer request from the client apparatus to transfer contents of the display screen to be displayed on the displaying unit;
transmitting to the client apparatus, in response to the transfer request, screen data corresponding to the screen to be displayed by the displaying unit; and
controlling a transmission of the screen data to the client apparatus based on whether a user of the client apparatus has an access right for the electronic document.

11. A computer-readable storage medium storing computer-executable process steps, the computer-executable process steps causing a computer to execute the method of claim 10.
